(19) United States
(12) Patent Application Publication
(10) Pub. No.: US 2023/0167250 A1
(43) Pub. Date: Jun. 1, 2023

(54) METHOD FOR PRODUCING A MOLDING COMPOUND

(71) Applicant: STAEDTLER MARS GMBH & CO. KG, Nümberg (DE)

(72) Inventor: Mathias BELZNER, Cadolzburg (DE)

(21) Appl. No.: 17/922,100

(22) PCT Filed: Apr. 23, 2021
(86) PCT No.: PCT/EP2021/025151

§ 371 Date: Oct. 28, 2022

(30) Foreign Application Priority Data
May 5, 2020 (DE) 10 2020 002 693.1

(51) Int. Cl. C08J 3/18; C08J 3/20; C08K 5/11

(52) U.S. Cl. CPC C08J 3/18; C08J 3/203; C08K 5/11; C08J 2327/06

(57) ABSTRACT

A method for producing molding compounds, at least including a binder and a softener, the binder and the softener being in the form of plastisols, the plastisol being essentially composed of PVC and softener, the method of production has the following steps: in a first step, mixing the PVC powder and the amount of softener with optionally other admixtures and/or additives and carrying out the mixing process at a mixing temperature of approximately 55 to 70° C.

The invention relates to a method for producing a molding compound.

Plastic molding compounds for shaping objects and methods for their production are known in principle. Objects can be designed manually or mechanically in industrial use.

Molding compounds are also understood to mean so-called clays or, in the case of polymer-containing compounds, so-called polymer clays. Such molding compounds have an extremely wide range of uses in today's everyday life.

Molding compounds in the form of modeling compounds are selected as examples from the prior art.

DE 25 15 757 C3 discloses a plastic compound that can be deformed by hand and hardened by heating.

Such a compound substantially consists of polyvinyl chloride (PVC), fillers and phthalate-containing plasticizers.

DE 10 2005 059 143 A1 also discloses modeling compounds that do not use phthalate-containing plasticizers.

The disadvantage of such compounds according to the selected prior art is that they are not resistant to aging and, for example, blocks of modeling compound exhibit an increase in hardness after prolonged storage, even in unopened packaging. As a result, the modeling compound is difficult for the user to knead.

This problem still represents the ideal case of aging, because long storage times can even lead to blocks of modeling compound and also molding materials in general becoming unusable since they can no longer be kneaded by hand.

This is due to the fact that the plasticizer in the compound already shows interactions at room temperature. This is referred to as an aging process of modeling compounds containing PVC in the unhardened state.

For modeling compounds according to the prior art mentioned, the powdery raw materials are mixed with the plasticizer at temperatures between 20 and 30° C. A plasticizer absorption of 25-30% by weight is achieved. Individual PVC agglomerates disintegrate in the course of time, for example, during longer storage, which in turn generates a need for plasticizers since the surface of the PVC grains has increased.

In this case, the plasticizer initially stored in the intermediate spaces between the PVC particles, which is largely responsible for the soft kneading/kneading behavior of the modeling compound, is no longer present. Instead, the plasticizer accumulates on the newly created surfaces of the disintegrated agglomerates. The hardness of the unhardened modeling compound increases over time as a result of this phenomenon.

The object of the invention is therefore to create a method for producing a molding compound that does not have the disadvantages mentioned and in particular to minimize the aging process during storage of PVC-containing molding compounds in the unhardened state and thus to ensure greater storage stability, which represents a particular consumer advantage.

The object is achieved with the features comprised in claim 1. Advantageous refinements and developments of the method according to the invention are comprised in the further claims.

Surprisingly, it has been shown that the object can be achieved with the method according to the invention for producing a molding compound by subjecting the binder (PVC powder) and a quantity of plasticizer with any other supplements and/or additives to a mixing process, the mixing process being carried out at a mixing temperature of from 55 to 70° C., preferably from 58 to 65° C.

The molding compound includes as components in the method according to the invention

| | |
|---|---|
| 20-68% by weight | binder, |
| 32-60% by weight | plasticizer, |
| 0-40% by weight | fillers and |
| 0-20% by weight | other additives |

A preferred embodiment of the molding compound includes in the method

| | |
|---|---|
| 40-68% by weight | binder, |
| 35-55% by weight | plasticizer, |
| 0-40% by weight | fillers and |
| 0-20% by weight | other additives |

A particularly preferred embodiment of the molding compound includes

| | |
|---|---|
| 45-63% by weight | binder |
| 38-52% by weight | plasticizer |
| 0-17% by weight | fillers |
| 0-15% by weight | other additives |

Surprisingly, it has been shown that by accommodating/introducing a higher amount of plasticizer into the PVC system of the molding compound, the increase in hardness of the compound over time is reduced, thus significantly improving the storage stability.

Furthermore, it has surprisingly been found that the more plasticizer that is added to the PVC powder, the higher the resulting flexibility of the compound after the hardening process. Said higher plasticizer content increases the flexibility of the hardened compound significantly.

It has also surprisingly been shown that the method according to the invention can also be used to achieve greater transparency after the hardening process.

The molding compounds produced using the method according to the invention consist of a binder, the binder being in the form of a plastisol, the plastisol being composed substantially of PVC and plasticizer and, optionally, other supplements and/or additives. The molding compound can comprise, for example, at least one filler as a further supplement and/or additive. A molding compound according to the invention is present when the content of plasticizer in the mixture is adjusted such that the plasticizer attaches itself to the surface of the PVC particles and is stored in the intermediate spaces between the solid particles, so that a “kneadable resistance” is formed. If the plasticizer content is too low, that is, the plasticizer only accumulates on the surface of the solid particles without also being present in the intermediate spaces, the compound is too hard or very difficult to shape, regardless of whether the molding compound is processed manually or by machine.

If, on the other hand, the surfaces of the solid particles and the intermediate spaces between the solid particles are completely covered or even oversaturated with plasticizer, the resulting molding material would flow too much and would therefore no longer be able to be shaped in a controlled manner.

In order to exemplify the principle of the method according to the invention, modeling materials were used for the description in order to clearly illustrate the invention over the prior art relating to modeling materials.

Heat must be supplied in order to convert the now shaped designed/modeled subject matter and objects into a permanently solid state. For modeling compound, for example, this is referred to as so-called bake hardening. The plasticizer or the plasticizer content is responsible for the hardening process, which allows the compound to harden due to interactions with the PVC.

However, it has been shown that the plasticizer has a certain affinity for the PVC granules or PVC solid particles even when stored at room temperature and ensures that the PVC granules, which partly consist of agglomerates, break down, thus generating new surfaces/surface areas. The plasticizer, which was stored in the intermediate spaces, migrates through said newly created surfaces to said newly created surfaces. As a result, the hardness of the molding compound increases because the moldability decreases due to the lack of liquid plasticizer components in the intermediate spaces.

The particular advantages are that the agglomerate disintegration (=aging process) can be brought forward in the production process using the method according to the invention by mixing at higher temperatures and with larger amounts of plasticizer.

This ultimately improves the storage stability or the increase in hardness of the unhardened compound over time, for example, by adding plasticizers in a targeted manner after the “aging process during the manufacturing process” has been initiated.

A further advantage that has resulted from the increased proportion/content of plasticizers in the molding compound is that the ability to gel in the system is improved during the hardening process, resulting in greater elasticity after hardening. Surprisingly, it has been shown that the transparency after bake hardening can be significantly increased by mixing at higher temperatures and the associated plasticizer contents and reducing the use of fillers and/or additives.

The binder used, which is essentially in the form of PVC, and the added plasticizer form a plastisol. The PVC can be present, among other things, as an emulsifier-containing or -free emulsion PVC, suspension PVC and microbead suspension PVC or a mixture of the individual PVC types.

Phthalate-free and/or phthalate-containing plasticizers can be used as plasticizers.

The total plasticizer content is between 32 and 60% by weight, in a preferred embodiment between 35 and 55% by weight and in a particularly preferred embodiment between 38 and 53% by weight.

The phthalate-free plasticizer is based on citric acid, adipic acid and/or benzoate ester.

The phthalate-free plasticizer is, for example, acetyl tributyl citrate, tri(2-ethylhexyl) acetyl citrate, trioctyl citrate, tridecyl citrate, tributyl citrate, trihexyl citrate, triethyl citrate, dioctyl adipate, diisodecyl adipate, diisononyl adipate, bis(2-ethylhexyl) adipate, diisononyl 1,2-cyclohexanedicarboxylate, acetic acid esters of monoglycerides, benzoates or a mixture of at least two of said substances. The plasticizer can further belong to the group of benzoates or benzoate esters. Its 2,2,4-triethyl-1,3-pentanediyl dibenzoate and derivatives thereof, triethylene glycol dibenzoate, diethylene glycol dibenzoate, diethylene glycol monobenzoate and/or propylene glycol dibenzoate are mentioned as examples. Any mixtures of all the aforementioned plasticizers are possible.

Examples of phthalate-containing plasticizers are di-2-ethylhexyl phthalate, ditridecyl phthalate and dibutyl phthalate.

Any mixture of phthalate-containing plasticizers is possible. It is also possible to use mixtures of plasticizers consisting of phthalate-free and phthalate-containing plasticizers.

A preferred embodiment of the inventive method is the production of molding compounds which are free from phthalate-containing plasticizers.

A stabilizer improves PVC stability, that is, it prevents, among other things, the splitting off of hydrogen chloride. Above all, inorganic and organic salts of the metals calcium, zinc, tin, magnesium, sodium and potassium are used for this purpose, for example, calcium stearate, sodium stearate, potassium stearate, zinc stearate, magnesium stearate, tin stearate and/or mixtures of the metal salts.

Inorganic and organic fillers which have a particle size <250 μm, preferably less than 100 μm, are substantially used as fillers, for example, kaolin, chalk, silica, talc, aluminum hydroxide and/or powdered clay.

Metal glitter, glitter powder and glitter flakes or mixtures of said substances can be present as further fillers in order to achieve special optical effects, for example.

So-called lightweight fillers can also be used as fillers, or other fillers mentioned can be admixed. Examples of lightweight fillers are hollow spheres, in particular hollow glass microspheres, for example, from the company 3M or Lehmann & Voss. Depending on the content of lightweight fillers, a desired density can be set, which is advantageously in the range from 0.3 to 1.1 g/ml. The size of commercially available lightweight fillers can also be chosen freely, their size preferably being in a range from 10 to 400 μm.

Furthermore, fillers based on polymers can also be used. PAMA, PMMA and/or polyethylene are named as examples of this group.

Pigments can be present as colorants in pure form, as powder pigments, preferably as azo-free color pigment, effect pigment and/or azo-free laked dye. A large number of possible color pigments includes Pigment Yellow 14 (C.I. 21095), Pigment Red 254 (C.I. 56110), Pigment Orange 34 (C.I. 21110) Pigment Red 122 (C.I. 73915) Pigment Green 7 (C.I. 74260), Pigment White 6 (C.I. 77891), Pigment Black 7 (C.I. 77266), Pigment Red 101 (C.I. 77491), Pigment Violet 23 (C.I. 51319), Pigment Blue 29 (C.I. 77007), Pigment Yellow 185 (C.I. 56290), Pigment Yellow 1 (C.I. 11680), Pigment Red 48:2 (C.I. 15865:2), Pigment Red 53:1 (C.I. 15585:1), Pigment Orange 34 (C.I. 21115), Pigment Yellow 83 (C.I. 21108) and Pigment Blue 15 (C.I. 74160).

The addition of these colorants gives the molding compound a brilliant appearance.

Pearlescent pigments, mica iron metal luster pigments, polyester glitter pigments and luminescent pigments may be specified as further colorants.

It can be seen here that differently colored molding compounds can also be blended, mixed or kneaded with one another as desired, resulting in a marbling effect.

The invention is to be illustrated in more detail using a framework example and some formulation examples using molding compounds.

### Framework Example 1 for a Molding Compound

| | |
|---|---|
| 20-68% by weight | binder |
| 32-60% by weight | plasticizer |
| 0-40% by weight | fillers |
| 0-20% by weight | other additives |

### Framework Example 2—Preferred Composition

| | |
|---|---|
| 40-68% by weight | binder |
| 35-55% by weight | plasticizer |
| 0-20% by weight | fillers |
| 0-20% by weight | other additives |

### Framework Example 3—Particularly Preferred Composition

| | |
|---|---|
| 45-63% by weight | binder |
| 38-53% by weight | plasticizer |
| 0-17% by weight | fillers |
| 0-15% by weight | other additives |

Stabilizers, co-stabilizers, colorants and/or fillers are examples of other additives that may be used.

### Formulation Example 1—Yellow Molding Compound

51% by weight E-PVC and S-PVC
42% by weight plasticizer based on ATBC
6% by weight stabilizer
0.5% by weight filler
0.5% by weight Pigment Yellow 83

### Formulation Example 2—Molding Compound, Transparent after Hardening

48% by weight E-PVC and S-PVC
52% by weight plasticizer based on ATBC

Prior Art—comparison formulation according to DE 10 2005 059 143
59% by weight PVC
24% by weight plasticizer based on citric acid
1% by weight stabilizers
7% by weight co-stabilizers
4% by weight filler
1% by weight Pigment Red 254

The preferably used phthalate-free plasticizer is based on citric acid and/or adipic acid.

A desired consistency of the compound can easily be adjusted by varying the binder content and/or plasticizer content.

The present invention is to be illustrated in more detail using modeling compounds on the basis of the following tables.

TABLE 1
Increase in hardness of the unhardened
compound as a function of time at 40° C.

| | 30 days/40° C. | 90 days/40° C. |
|---|---|---|
| Composition according to the | Delta H 10% | Delta H 13% |
| invention Formulation Example 2 | | |
| Prior art compound | Delta H 245% | Delta H 386% |
| Comparative example | | |

It has been shown that the compound that has not yet hardened in the oven according to the application documents compared to the prior art, when stored at 40° C. over time (30 or 90 days), has a significantly lower increase in hardness, as shown in Table 1.

TABLE 2
Flexibility of the hardened modeling compound

| | Flexibility/deflection |
|---|---|
| | to break in mm |
| Composition according to the | 28 |
| invention Formulation Example 2 | |
| Prior art compound | 6 |
| Comparative example | |

These higher breaking strengths could be determined and confirmed with a “Texture Analyzer”. Round fracture bars having a length of 10 cm and a diameter of 1 cm are produced as test specimens.

Molding compounds produced according to the invention are used in automobile construction, household items, medical equipment, toys and the food industry, and also accessories for the aforementioned uses.

Articles and objects formed with molding compounds produced according to the invention are hardened after shaping by the action of heat.

The method for producing molding compounds, consisting at least of a binder and a plasticizer, the binder and the plasticizer being in the form of a plastisol, the plastisol being composed substantially of PVC and plasticizer, is carried out by subjecting the PVC powder and the amount of plasticizer with optionally other supplements and/or additives to a mixing process, the mixing process taking place at a mixing temperature of between 55 and 70° C.

1-6. (canceled)

7. A method for producing a molding compound, including at least a binder and a plasticizer, the binder and the plasticizer being in the form of a plastisol, the plastisol being composed substantially of PVC and plasticizer, the method comprising the steps of: subjecting a PVC powder and an amount of plasticizer with any other supplements and/or additives to a mixing process at a mixing temperature of 55 to 70° C.

8. The method according to claim 7, wherein a plasticizer content is between 32 and 60% by weight.

9. The method according to claim 8, wherein the plasticizer content is between 35 and 55% by weight.

10. The method according to claim 9, wherein the plasticizer content is between 38 and 53% by weight.

11. The method according to claim 7, wherein the plasticizer is formed as a phthalate-free or a phthalate-containing plasticizer.

12. The method according to claim 11, wherein the phthalate-free plasticizer is based on citric acid, adipic acid and/or benzoate ester.

13. The method according to claim 11, wherein the phthalate-free plasticizer is acetyl tributyl citrate, tri(2-ethylhexyl) acetyl citrate, trioctyl citrate, tridecyl citrate, tributyl citrate, trihexyl citrate, triethyl citrate, dioctyl adipate, diisodecyl adipate, diisononyl adipate, diisononyl 1,2-cyclohexanedicarboxylate, acetic acid ester of monoglycerides, benzoates or a mixture of at least two of said substances.

14. The method according to claim 7, wherein the molding compound is composed of at least
20-68% by weight binder
32-60% by weight plasticizer
0-40% by weight filler
0-20% by weight other additives.
